(19) United States
(12) Patent Application Publication
(10) Pub. No.: US 2010/0153318 A1
(43) Pub. Date: Jun. 17, 2010

(54) Methods and systems for automatically summarizing semantic properties from documents with freeform textual annotations

(75) Inventors: Satchuthananthavale Rasiah Kuhan Branavan, Cambridge, MA (US); Harr Chen, Cambridge, MA (US); Jacob Richard Eisenstein, Pittsburgh, PA (US); Regina Barzilay, Cambridge, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 12/592,128

(22) Filed: Nov. 19, 2009

Related U.S. Application Data
(60) Provisional application No. 61/116,065, filed on Nov. 19, 2008.

(51) Int. Cl. G06F 15/18; G06N 5/02

(52) U.S. Cl. 706/12; 706/46

(57) ABSTRACT

Some embodiments are directed to identifying semantic properties of documents using free-text annotations associated with the documents. Semantic properties of documents may be identified by using a model that is trained on a corpus of training documents where one or more of the training documents may include free-text annotations. In some embodiments, the model may identify semantic topics expressed only in free-text annotations or only in the body of a document. The model may applied to identify semantic topics associated with a work document or to summarize the semantic topics present in a plurality of work documents.

### RELATED APPLICATIONS

This application claims priority under 35 U.S.C. §119(e) to U.S. Provisional Application Ser. No. 61/116,065, entitled “System and Method for Automatically Summarizing Semantic Properties from Documents with Freeform Textual Annotations,” filed on Nov. 19, 2008, which is herein incorporated by reference in its entirety.

### FEDERALLY SPONSORED RESEARCH

This invention was sponsored by the Air Force Office of Scientific Research under Grant No. FA8750-06-2-0189. The Government has certain rights to this invention.

### COMPUTER PROGRAM LISTING APPENDIX

The present disclosure also includes as an appendix two copies of a CD-ROM containing computer program listings containing exemplary implementations of one or more embodiments described herein. The two CD-ROMs are exactly the same, and are finalized so that no further writing is possible. The CD-ROMs are compatible with IBM PC/XT/AT compatible computers running the Windows Operating System. Both CD-ROMs contain the following files:

| Filename | Size | Creation Date |
|---|---|---|
| model.cpp | 50215 bytes | Nov. 17, 2009 |
| README_for_matlab_code.TXT | 1104 bytes | Nov. 14, 2008 |
| infer_opinions.m | 1533 bytes | Nov. 13, 2008 |
| run_training.m | 2910 bytes | Nov. 13, 2008 |
| sample_At_for_words_v1.c | 3166 bytes | Nov. 13, 2008 |
| sample_dirichlet.m | 857 bytes | Nov. 13, 2008 |
| sample_topics_for_words_v3.c | 4705 bytes | Nov. 13, 2008 |
| train_model_v4_2.m | 19062 bytes | Nov. 13, 2008 |

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by the law, but otherwise reserves all copyright rights whatsoever.

### BACKGROUND OF INVENTION

1. Field of Invention

The present invention relates to the field of natural language understanding. More particularly, it relates to identifying at least one semantic topic from textual documents.

2. Discussion of Related Art

Natural language understanding can be applied to a variety of tasks. One example is the extraction of meaning from textual reviews, such as restaurant reviews. The extraction of meaning from a review can involve identifying a “semantic topic” contained within the review. A semantic topic is a meaning present in the review, such as an opinion that the restaurant has good food. A reviewer can express that meaning in numerous ways, including by the phrases “good food,” “excellent meal,” “tasty menu,” and numerous other ways.

A review of a restaurant may express more than one semantic topic—e.g., “good food,” “inexpensive,” and “bad service.” By automatically processing a number of reviews to extract these and/or other semantic topics, the reviews may be more useful. For example, a person may only be interested in reading restaurant reviews where the food is inexpensive. Natural language understanding allows for the automatic processing of free text reviews so that this person can obtain reviews that are likely to be discussing inexpensive restaurants.

Semantic topics can be extracted from many different types of documents, and these documents may vary in their structure. Some documents may contain only free text, while other documents may contain additional information, which may be quantitative or non-quantitative in nature. For the example of restaurant reviews, additional quantitative information may include a ranking of one to five stars and additional non-quantitative information may include a title of the review.

Non-quantitative information that is associated with a document may be referred to as a “free-text annotation.” Such free-text annotations may relate to the semantic topics contained in the document. For example, a restaurant review may have a title, such as “best food in the city.” Other reviews may have a listing of “pros” and “cons” entered by the reviewer that may summarize the more salient features of the review. For example, a restaurant review may have pros of “great food” and “nice decor” and cons of “overpriced” and “poor service.”

Conventional techniques for extracting semantic topics from documents, such as textual reviews, typically employ a statistical model. The statistical model is first created from a corpus of training documents, and then applied to extract semantic topics from one or more test or working documents.

One technique for creating a statistical model involves the use of an expert-annotated corpus. To create an expert-annotated corpus, people are hired to read documents (e.g., reviews) and identify the semantic topics present in each. A model can then be created from the expert-annotated corpus.

Another technique for creating a statistical model requires that a person identify in advance specific phrases that relate to a semantic topic of interest. For example, a person can identify in advance that reviews containing the phrases “good food,” “excellent meal,” and “tasty menu,” relate to the semantic topic expressing that the restaurant has good food. The documents in the training corpus that contain exactly these phrases will be associated with the semantic topic.

Another technique for creating a statistical model is called latent Dirichlet allocation (LDA). With LDA, the documents in a training corpus are used to create the model, but semantic topics are not pre-identified in the documents. The LDA technique infers the semantic topics that are present in the work or training documents from only the documents themselves.

Another technique for creating a statistical model is called supervised latent Dirichlet allocation (sLDA). This technique is an extension of LDA that uses a quantifiable variable to influence the identification of the latent semantic topics and also to improve the accuracy of the model. For example, movie reviews may contain a ranking of one to five stars. This ranking may be used to influence the latent semantic topics to be aligned with the reviewer's overall impression of the movie (as opposed to other semantic topics relating to the movie such as the length of the movie or the soundtrack) and also to improve the accuracy of the model.

### SUMMARY OF INVENTION

Applicants have appreciated some disadvanteges with conventional approaches for identifying semantic topics in documents. For example, one disadvantage of using an expert-annotated corpus is the cost of performing the expert annotation. One disadvantage of having a person identify in advance specific phrases that relate to a semantic topic of interest is that any given semantic topic can be expressed using a variety of different phrases, and it is difficult to identify in advance all phrases relating to a semantic topic. One disadvantage of LDA is that it is not capable of taking advantage of free-text annotations associated with documents. For example, with LDA, the model cannot take advantage of a list of “pros” and “cons” that are associated with a review. One disadvantage of sLDA is that it cannot use free-text annotations, such as a list of “pros” and “cons,” to improve the accuracy of the model.

Applicants have appreciated that a corpus of training documents containing free-text annotations may be used to improve the accuracy of a model that identifies semantic topics in documents. As free-text annotations may be created contemporaneously by the author, the annotations may relate to the most salient portions of the document.

In accordance with one exemplary embodiment, systems and methods are provided for using a model to associate semantic topics with documents, wherein the model may be created from a corpus of training documents that include one or more free-text annotations. After the model is created, it may be applied to identify semantic topics in one or more work documents. This aspect of the invention can be implemented in any suitable manner, examples of which are described in the attachment. However, it should be appreciated that this aspect of the invention is not limited to any specific implementation.

This aspect of the invention provides a number of advantages over prior-art methods. For example, the need for creating an expertly annotated training set is eliminated. In addition, the model does not require that a user identify in advance what phrases are associated with a semantic topic. Rather, by analyzing a set of training documents, the model may learn what semantic topics are present in the training documents and may learn different phrases that can be used to describe the same semantic topic. The model also uses free-text annotations to learn about semantic topics, which may provide a more accurate model than a model created without free-text annotations.

It should be appreciated that free-text annotations are not limited to any particular format or structure. A free-text annotation may be in the format of a “title,” a “subject,” a list of “pros” or “cons,” a list of “tags,” or any other free text that can be associated with a document.

The model created in accordance with some embodiments is flexible in that it can identify semantic topics regardless of where they appear. Thus, the model may be able to associate a document with a semantic topic where the semantic topic is expressed in a free-text annotation but not in the body of the document or vice versa. For example, a reviewer may state in a free-text annotation that a restaurant has “incredible food” and may address other topics in the body of the review, or a reviewer may describe in the body of the review the high quality of a restaurant's food but not include a free-text annotation on that subject. In one embodiment, as described in the attachment, this flexibility may be achieved by employing a model that comprises two sub-models where the first sub-model identifies semantic topics in free-text annotations and the second sub-model identifies semantic topics in the body of a document, but the invention is not limited in this respect and any suitable implementation may be used.

It should be appreciated that the model created in accordance with some embodiments is able to learn different ways of expressing a semantic topic. In the corpus of training documents, a semantic topic may be expressed in a variety of ways (in the free-text annotations and/or the body of the documents). By analyzing the training documents, the model is able to learn that these different expressions relate to the same semantic topic. This learning allows the model to associate two training documents with the same semantic topic even though it is expressed in different ways, and further allows the model to identify a work document as being associated with a semantic topic even though the work document expresses the semantic topic in a different manner than all of the training documents. For example, one training document may include a free-text annotation of “incredible food” and another training document may state “delectable meal” in the body of the review. The model may be able to learn that both of these phrases express the same semantic topic of favorable food quality, and may also be able to determine that a work document containing a previously unseen phrase, such as “delectable food” also relates to this same semantic topic. This aspect of the invention can be implemented in any suitable manner and is not limited to the specific examples described in the attachment.

In some embodiments, the model may learn different ways of expressing a semantic topic by assigning similarity scores to free-text annotations. The similarity scores may indicate how similar a free-text annotation is to other free-text annotations, and the scores may be used to cluster free-text annotations so that free-text annotations in the same cluster are likely to express the same semantic topic. By providing the similarity scores to the model, the ability of the model to identify semantic topics in work documents may be improved. It should be appreciated that the similarity scores for a free-text annotation need not be in a particular format. For example, the similarity scores for a particular free-text annotation could be in the form of a vector where each element of the vector indicates the similarity between the free-text annotation and another free-text annotation. Further, the similarity scores are not limited to being computed in any particular manner, and can be computed from the word distributions in the free-text annotations or can be computed by using other information. The similarity scores can be implemented in any suitable way, examples of which are described in the attached document.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows excerpts from an example of online restaurant reviews with free-text annotations (e.g., pro/con phrase lists) from which semantic topics can be identified in accordance with some embodiments;

FIG. 2 shows examples of paraphrases related to the property of good price that may appear in the pros/cons keyphrases in the reviews of FIG. 1 and similar reviews;

FIG. 3 shows occurrence counts for the top ten keyphrases associated with the good service property of FIG. 2;

FIG. 4 shows an exemplary plate diagram for a model to identify semantic topics in documents in accordance with some embodiments;

FIG. 5 shows a summary of reviews for the movie Pirates of the Caribbean: At World's End where the list of pros and cons has been generated automatically using embodiments of the invention;

FIG. 6 is a computer system on which embodiments of the invention may be implemented;

FIG. 7 is a model for identifying semantic topics in documents, in accordance with some embodiments, where the model comprises a sub-model for identifying semantic topics in free-text annotations and sub-model for identifying semantic topics in the body of a document;

FIG. 8 is a flow chart of an illustrative process for identifying a semantic topic in a document in accordance with some embodiments;

FIG. 9 is a flow chart of an illustrative process for creating a model to identify semantic topics in documents using similarity scores in accordance with some embodiments; and

FIG. 10 is a keyphrase similarity matrix from a set of restaurant reviews, computed according to Table 2.

### DETAILED DESCRIPTION

### 1 Overview

Identifying the document-level semantic properties implied by a text or set of texts is a problem in natural language understanding. For example, given the text of a restaurant review, it could be useful to extract a semantic-level characterization of the author's reaction to specific aspects of the restaurant, such as the food, service, and so on. As mentioned above, learning-based approaches have dramatically increased the scope and robustness of such semantic processing, but they are typically dependent on large expert-annotated datasets, which are costly to produce.

Applicants have recognized an alternative source of annotations: free-text keyphrases produced by novice end users. As an example, consider the lists of pros and cons that often accompany reviews of products and services. Such end-user annotations are increasingly prevalent online, and they grow organically to keep pace with subjects of interest and socio-cultural trends. Beyond such pragmatic considerations, free-text annotations may be appealing from a linguistic standpoint because they may capture the intuitive semantic judgments of non-specialist language users. In many real-world datasets, these annotations may be created by the document's original author, providing a direct window into the semantic judgments that motivated the document text.

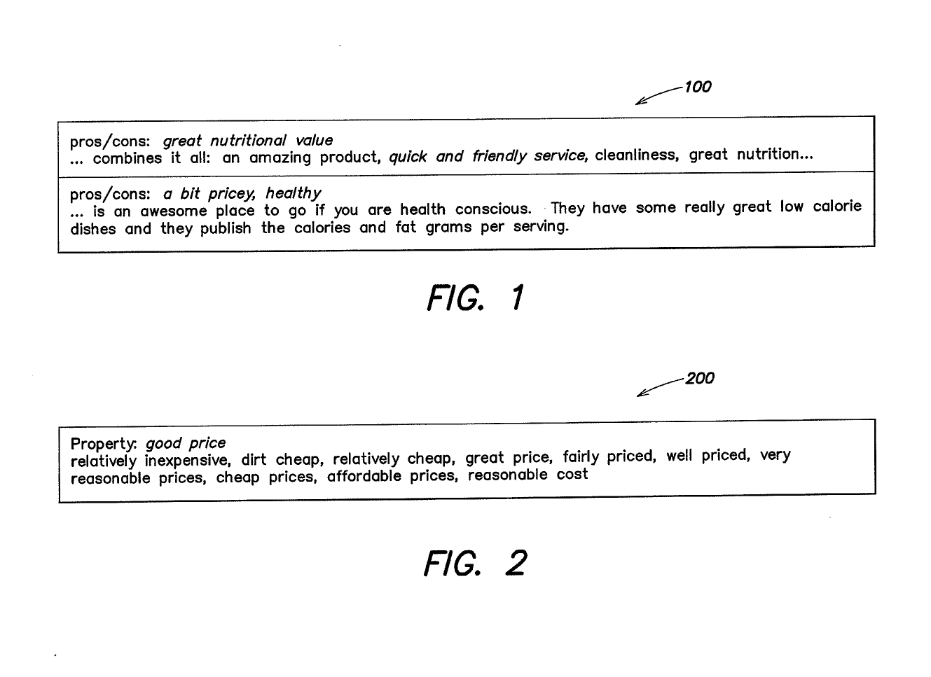

One aspect of the computational use of such free-text annotations is that they may be noisy—there may be no fixed vocabulary, no explicit relationship between annotation keyphrases, and no guarantee that all relevant semantic properties of a document will be annotated. For example, consider pro and con annotations 100 that may accompany consumer reviews, as shown in FIG. 1. FIG. 1 shows excerpts from online restaurant reviews with pro/con phrase lists. Both reviews assert that the restaurant serves healthy food, but use different keyphrases. Additionally, the first review discusses the restaurant's good service, but is not annotated as such in its keyphrases. The same underlying semantic idea may expressed in different ways, through the keyphrases “great nutritional value” and “healthy.” Additionally, the first review discusses quality of service, but is not annotated as such. In annotations produced by experts, synonymous keyphrases would be replaced by a single canonical label, and annotations would cover all semantic properties described in the text. Prior methods, such as supervised LDA, are designed for expert annotations of this form.

Some embodiments of the invention demonstrate a new approach for handling free-text annotation in the context of a hidden-topic analysis of the document text. In these embodiments regularities in the text may clarify noise in the annotations—for example, although “great nutritional value” and “healthy” have different surface forms, the text in documents that are annotated by these two keyphrases may be similar. By modeling the relationship between document text and annotations over a large dataset, it may be possible to induce a clustering over the annotation keyphrases that can help to overcome the problem of inconsistency. The model may also address the problem of incompleteness—when novice annotators fail to label relevant semantic topics—by estimating which topics are predicted by the document text alone.

One aspect of this approach is the idea that both document text and the associated annotations may reflect a single underlying set of semantic properties. In the text, the semantic properties may correspond to the induced hidden topics. In some embodiments, the hidden topics in the text may be tied with clusters of keyphrases because both the text and the annotations may be grounded in a shared set of semantic properties. By modeling these properties directly, the system may infer that the hidden topics are semantically meaningful, and the clustering over noisy annotations may be robust to noise.

In one embodiment, a hierarchical Bayesian framework is employed, and includes an LDA-style component in which each word in the text may be generated from a mixture of multinomials. In addition, the system may also incorporate a similarity matrix across the universe of annotation keyphrases, which is constructed based on the keyphrases' orthographic and distributional properties. The system models this matrix as generated from an underlying clustering over the keyphrases, such that keyphrases that are clustered together are likely to produce high similarity scores. To generate the words in each document, the system may model two distributions over semantic properties—one governed by the annotation keyphrases and their clusters, and a background distribution to cover properties not mentioned in the annotations. The latent topic for each word may be drawn from a mixture of these two distributions. After learning model parameters from a noisily-labeled training set, the system may apply the model to unlabeled data.

The system may build a model by extracting semantic properties from reviews of products and services, using a training corpus that includes user-created free-text annotations of the pros and cons in each review. Training may yield two outputs: a clustering of keyphrases into semantic properties, and a topic model that is capable of inducing the semantic properties of unlabeled text. The clustering of annotation keyphrases may be relevant for applications such as content-based information retrieval, allowing users to retrieve documents with semantically relevant annotations even if their surface forms differ from the query term. The topic model may be used to infer the semantic properties of unlabeled text.

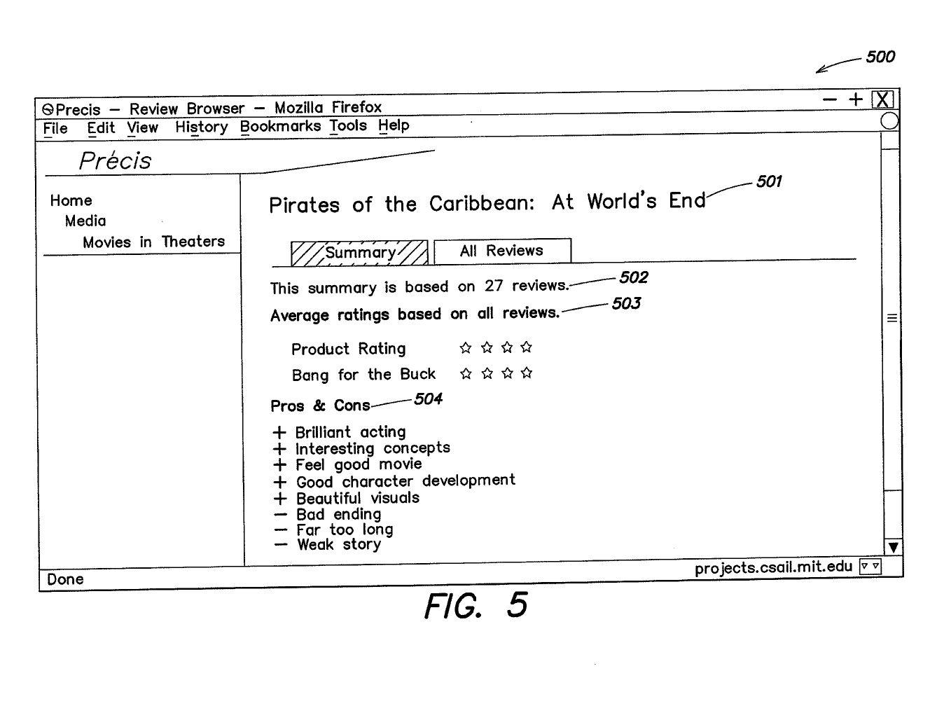

The topic model may also be used to perform multidocument summarization, capturing the key semantic properties of multiple reviews. Unlike traditional extraction-based approaches to multidocument summarization, one embodiment may use an induced topic model that abstracts the text of each review into a representation capturing the relevant semantic properties. This enables comparison between reviews even when they use superficially different terminology to describe the same set of semantic properties. This idea may be implemented in a review aggregation system that extracts the majority sentiment of multiple reviewers for a single product or service. An example of the output produced by this system is shown in FIG. 5.

An embodiment of the invention was applied to reviews in 480 domains, allowing users to navigate the semantic properties of 49,490 products based on a total of 522,879 reviews. The effectiveness of the approach is confirmed by several evaluations. For the summarization of both single and multiple documents into their key semantic properties, the system may compare the properties inferred by the model with expert annotations. The present approach yields substantially better results than previous approaches; in particular, the system may find that learning a clustering of free-text annotation keyphrases is useful to extracting meaningful semantic properties from the dataset. In addition, the system may compare the induced clustering with a gold standard clustering produced by expert annotators. The comparison shows that tying the clustering to the hidden topic model substantially improves its quality, and that the clustering induced by the topic model coheres well with the clustering produced by expert annotators.

In the discussion below, Section 2 compares the disclosed approach with previous work on topic modeling, semantic property extraction, and multidocument summarization. Section 3 describes characteristics an example dataset with free-text annotations. Embodiments of the model are described in Section 4, and embodiments of a method for parameter estimation are presented in Section 5. Section 6 describes the implementation and evaluation of some embodiments of single-document and multi-document summarization systems using these techniques.

### 2 Related Work

Related work in this area includes Bayesian topic modeling, methods for identifying and analyzing product properties from the review text, and multidocument summarization.

2.1 Bayesian Topic Modeling

Recent work in the topic modeling literature has demonstrated that semantically salient topics can be inferred in an unsupervised fashion by constructing a generative Bayesian model of the document text. One example of this line of research is Latent Dirichlet Allocation. In the LDA framework, semantic topics may be equated to latent distributions that govern the distribution of words in a text; thus, each document may be modeled as a mixture of topics. This class of models can been used for a variety of language processing tasks including topic segmentation, named-entity resolution, sentiment ranking, and word sense disambiguation.

One embodiment is similar to LDA in that it assigns latent topic indicators to each word in the dataset, and models documents as mixtures of topics. However, the LDA model may be unsupervised, and may not provide a method for linking the latent topics to external observed representations of the properties of interest. In contrast, in one embodiment, a model may be used that exploits the free-text annotations in the dataset so that that the induced topics may correspond to semantically meaningful properties.

Combining topics induced by LDA with external supervision were considered by Blei and McAuliffe in their supervised Latent Dirichlet Allocation (sLDA) model. The induction of the hidden topics is driven by annotated examples provided during the training stage. From the perspective of supervised learning, this approach succeeds because the hidden topics mediate between document annotations and the level of lexical features. Blei and McAuliffe describe a variational expectation-maximization procedure for approximate maximum-likelihood estimation of the model's parameters. When tested on two polarity assessment tasks, sLDA shows improvement over a model in which topics where induced by an unsupervised model and then added as features to a supervised model.

In accordance with one embodiment, the system may not have access to clean supervision data during training as is done with sLDA. Since the annotations may be free-text in nature, they may be incomplete and fraught with inconsistency. Thus, in accordance with one embodiment, benefits are achieved by employing a model that simultaneously induces the hidden structure in free-text annotations and learns to predict properties from text.

2.2 Property Assessment for Review Analysis

In one embodiment, according to the techniques described herein, the model may be applied to the task of review analysis. Traditionally, the task of identifying the properties of a product based on review texts has been cast as an extraction problem. For example, Hu and Liu employ association mining to identify noun phrases that express key portions of product reviews. The polarity of the extracted phrases is determined using a seed set of adjectives expanded via WordNet relations. A summary of a review is produced by extracting all property phrases present verbatim in the document.

Property extraction was further refined in Opine, another system for review analysis. Opine employs a novel information extraction method to identify noun phrases that could potentially express the salient properties of reviewed products; these candidates are then pruned using WordNet and morphological cues. Opinion phrases are identified using a set of hand-crafted rules applied to syntactic dependencies extracted from the input document. The semantic orientation of properties is computed using a relaxation labeling method that finds the optimal assignment of polarity labels given a set of local constraints. Empirical results demonstrate that Opine outperforms Hu and Liu's system in both opinion extraction and in identifying the polarity of opinion words.

These two feature extraction methods are informed by human knowledge about the way opinions are typically expressed in reviews: for Hu and Liu, human knowledge is expressed via WordNet and the seed adjectives; for Popescua, opinion phrases are extracted via hand-crafted rules. An alternative approach is to learn the rules for feature extraction from annotated data. To this end, property identification can be modeled in a classification framework. A classifier is trained using a corpus in which free-text pro and con keyphrases are specified by the review authors. These keyphrases are compared against sentences in the review text; sentences that exhibit high word overlap with previously identified phrases are marked as pros or cons according to the phrase polarity. The rest of the sentences are marked as negative examples.

Clearly, the accuracy of the resulting classifier may depend on the quality of the automatically induced annotations. An analysis of free-text annotations in several domains shows that automatically mapping from even manually-extracted annotation keyphrases to a document text may be a difficult task, due to variability in their surface realizations (see Section 3). It may be beneficial to explicitly address the difficulties inherent in free-text annotations. To this end, some embodiments may be distinguished in two significant ways from the property extraction methods described above. First, the system may be able to predict properties beyond those that appear verbatim in the text. Second, the system may also learn the semantic relationships between different keyphrases, allowing us to draw direct comparisons between reviews even when the semantic ideas are expressed using different surface forms.

Working in the related domain of web opinion mining, Lu and Zhai describe a system that generates integrated opinion summaries, which incorporate expert-written articles (e.g., a review from an online magazine) and user-generated “ordinary” opinion snippets (e.g., mentions in blogs). Specifically, the expert article is assumed to be structured into segments, and a collection of representative ordinary opinions is aligned to each segment. Probabilistic Latent Semantic Analysis (PLSA) is used to induce a clustering of opinion snippets, where each cluster is attached to one of the expert article segments. Some clusters may also be unaligned to any segment, indicating opinions that are entirely unexpressed in the expert article. Ultimately, the integrated opinion summary is this combination of a single expert article with multiple user-generated opinion snippets that confirm or supplement specific segments of the review.

In accordance with one embodiment, the system may provide a highly compact summary of a multitude of user opinions by identifying the underlying semantic properties, rather than supplementing a single expert article with user opinions. The system may leverage annotations that users already provide in their reviews, thus obviating the need for an expert article as a template for opinion integration. Consequently, some embodiments may be more suitable for the goal of producing concise keyphrase summarizations of user reviews, particularly when no review can be taken as authoritative.

Another approach is a review summarizer developed by Titov and McDonald. Their method summarizes a review by selecting a list of phrases that express writers' opinions in a set of predefined properties (e.g., food and ambiance for restaurant reviews). The system may not have access to numerical ratings in the same set of properties, but there is no training set providing examples of appropriate keyphrases to extract. Similar to sLDA, their method uses the numerical ratings to bias the hidden topics towards the desired semantic properties. Phrases that are strongly associated with properties via hidden topics are extracted as part of a summary.

There are several differences between some embodiments described herein and the summarization method of Titov and McDonald. Their method assumes a predefined set of properties and thus cannot capture properties outside of that set. Moreover, consistent numerical annotations are required for training, while embodiments described herein emphasize the use of free-text annotations. Finally, since Titov and McDonald's algorithm is extractive, it does not facilitate property comparison across multiple reviews.

2.3 Multidocument Summarization

Researchers have long noted that a central challenge of multidocument summarization is identifying redundant information over input documents. This task is significant because multidocument summarizers may operate over related documents that describe the same facts multiple times. In fact, one may assume that repetition of information among related sources is an indicator of its importance. Many of these algorithms first cluster sentences together, and then extract or generate sentence representatives for the clusters.

Identification of repeated information is also part of embodiments of the approach described herein—a multidocument summarization method may select properties that are stated by a plurality of users, thereby eliminating rare and/or erroneous opinions. A difference between an algorithm described herein according to one embodiment and existing summarization systems is the method for identifying repeated expressions of a single semantic property. Since most of the existing work in multidocument summarization focuses on topic-independent newspaper articles, redundancy is identified via sentence comparison. For instance, Radev compares sentences using cosine similarity between corresponding word vectors. Alternatively, some methods compare sentences via alignment of their syntactic trees. Both string- and tree-based comparison algorithms are augmented with lexico-semantic knowledge using resources such as WordNet.

Some embodiments do not perform comparisons at the sentence level. Instead, the system may first abstract reviews into a set of properties and then compare property overlap across different documents. This approach may relate to domain-dependent approaches for text summarization. These methods may identify the relations between documents by comparing their abstract representations. In these cases, the abstract representation may be constructed using off-the-shelf information extraction tools. The template that specifies what types of information to select may be crafted manually for a domain of interest. Moreover, the training of information extraction systems may require a corpus manually annotated with the relations of interest. In contrast, embodiments described herein do not require a manual template specification or corpora annotated by experts. While the abstract representations that the system may induce are not as linguistically rich as extraction templates, they nevertheless enable us to perform in-depth comparisons across different reviews.

### 3. Analysis of Free-Text Keyphrase Annotations

TABLE 1
Incompleteness and inconsistency in the restaurant domain, for
six major properties prevalent in restaurant reviews.

| | | | | Inconsistency | |
|---|---|---|---|---|---|
| | | | | | Top |
| | Incompleteness | | | Keyphrase | Keyphrase |
| Property | Recall | Precision | F-score | Count | Coverage % |
| Good food | 0.736 | 0.968 | 0.836 | 23 | 38.3 |
| Good service | 0.329 | 0.821 | 0.469 | 27 | 28.9 |
| Good price | 0.500 | 0.707 | 0.586 | 20 | 41.8 |
| Bad food | 0.516 | 0.762 | 0.615 | 16 | 23.7 |
| Bad service | 0.475 | 0.633 | 0.543 | 20 | 22.0 |
| Bad price | 0.690 | 0.645 | 0.667 | 15 | 30.6 |
| Average | 0.578 | 0.849 | 0.688 | 22.6 | 33.6 |

The incompleteness figures are the recall, precision, and F-score of the author annotations (manually clustered into properties) against the gold standard property annotations.
Inconsistency is measured by the number of different keyphrase realizations with at least five occurrences associated with each property, and the percentage frequency with which the most commonly occurring keyphrases is used to annotate a property.
The averages in the bottom row are weighted according to frequency of property occurrence.

This section explores the characteristics of free-text annotations and the quantification of the degree of noise observed in this data. The results of this analysis motivate the development of embodiments described below.

One example is the domain of online restaurant reviews using documents downloaded from the popular Epinions website. Users of this website evaluate products by providing both a textual description of their opinion, as well as concise lists of keyphrases (pros and cons) summarizing the review. Pro/con keyphrases are an appealing source of annotations for online review texts. However, they are contributed by multiple users independently and may not be as clean as expert annotations. Two aspects of free-text annotations are incompleteness and inconsistency. The measure of incompleteness quantifies the degree of label omission in free-text annotations, while inconsistency reflects the variance of the keyphrase vocabulary used by various annotators.

To test the quality of these user-generated annotations, one may compare them against “expert” annotations produced in a more systematic fashion. This annotation effort focused on six properties that were commonly mentioned by the review authors, specifically those shown in Table 1. Given a review and a property, the task is to assess whether the review's text support the property. These annotations were produced by two judges guided by a standardized set of instructions. In contrast to author annotations from the website, the judges conferred during a training session to ensure consistency and completeness. The two judges collectively annotated 170 reviews, with 30 annotated by both. Cohen's Kappa, a measure of inter-annotator agreement that ranges from zero to one, is 0.78 on this joint set, indicating high agreement. On average, each review text was annotated with 2.56 properties.

Separately, one of the judges also standardized the free-text pro/con annotations for the same 170 reviews. Each review's keyphrases were matched to the same six properties. This standardization allows for direct comparison between the properties judged to be supported by a review's text and the properties described in the same review's free-text annotations. Many semantic properties that were judged to be present in the text were not user-annotated—on average, the keyphrases expressed 1.66 relevant semantic properties per document, while the text expressed 2.56 properties. This gap demonstrates the frequency with which authors failed to annotate relevant semantic properties of their reviews.

3.1 Incompleteness

To measure incompleteness, one may compare the properties stated by review authors in the form of pros and cons against those stated only in the review text, as judged by expert annotators. This comparison may be performed using precision, recall and F-score. In this setting, recall is the proportion of semantic properties in the text for which the review author also provided at least one annotation keyphrase; precision is the proportion of keyphrases that conveyed properties judged to be supported by the text; and F-score is their harmonic mean. The results of the comparison are summarized in the left half of Table 1

These incompleteness results demonstrate the significant discrepancy between user and expert annotations. As expected, recall is quite low; more than 40% of property occurrences are stated in the review text without being explicitly mentioned in the annotations. The precision scores indicate that the converse is also true, though to a lesser extent—some keyphrases will express properties not mentioned in text.

Interestingly, precision and recall vary greatly depending on the specific property. They are highest for good food, matching an intuitive notion that high food quality would be a key salient property of a restaurant, and thus more likely to be mentioned in both text and annotations. Conversely, the recall for good service is lower—for most users, high quality of service is not a key point when summarizing a review with keyphrases.

3.2 Inconsistency

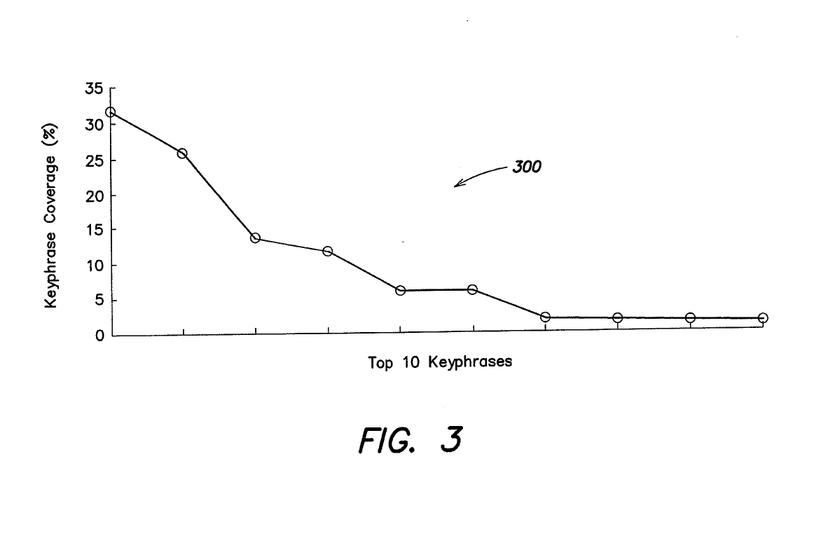

FIG. 3 shows occurrence counts 300 for the top ten keyphrases associated with the good service property. The percentages are out of a total of 1,210 separate keyphrase occurrences for this property. The relatively diffuse counts for the variety of different paraphrases make the point that focusing on just a few frequent keyphrases would neglect many property occurrences.

The lack of a unified annotation scheme in the restaurant review dataset is apparent—across all reviewers, the annotations feature 26,801 unique keyphrase surface forms over a set of 49,310 total keyphrase occurrences. Clearly, many unique keyphrases express the same semantic property—in FIG. 3, good service is expressed in at least ten different ways. To quantify this phenomenon, the judges manually clustered a subset of the keyphrases associated with the six previously mentioned properties. Specifically, 121 keyphrases associated with the six major properties were chosen, accounting for 10.8% of all keyphrase occurrences.

The system may use these manually clustered annotations to examine the distributional pattern of keyphrases that describe the same underlying property, using two different statistics. First, the number of different keyphrases for each property may give a lower bound on the number of possible paraphrases. Second, the system may measure how often the most common keyphrase is used to annotate each property, i.e., the “coverage” of that keyphrase. This metric may give a sense of how “diffuse” the keyphrases within a property are, and specifically whether one single keyphrase dominates occurrences of the property.

The latter half of Table 1 summarizes the variability of property paraphrases. Observe that each property may be associated with numerous paraphrases, all of which were found multiple times in the actual keyphrase set. Most importantly, the most frequent keyphrase accounted for only about a third of all property occurrences, suggesting that targeting only these labels for learning is a very limited approach. To further illustrate this last point, consider the property of good service, whose keyphrase realizations' distributional histogram 300 appears in FIG. 3. The percentage frequencies of the most frequent keyphrases associated with this property are plotted. Because the distribution exhibits strong heterogeneity, the system may not approximate property annotations by merely considering high-frequency keyphrases in the user annotations.

The next section introduces some embodiments of a model that induces a clustering among keyphrases while relating keyphrase clusters to the text, and addressing these characteristics of the data.

### 4 Model Description

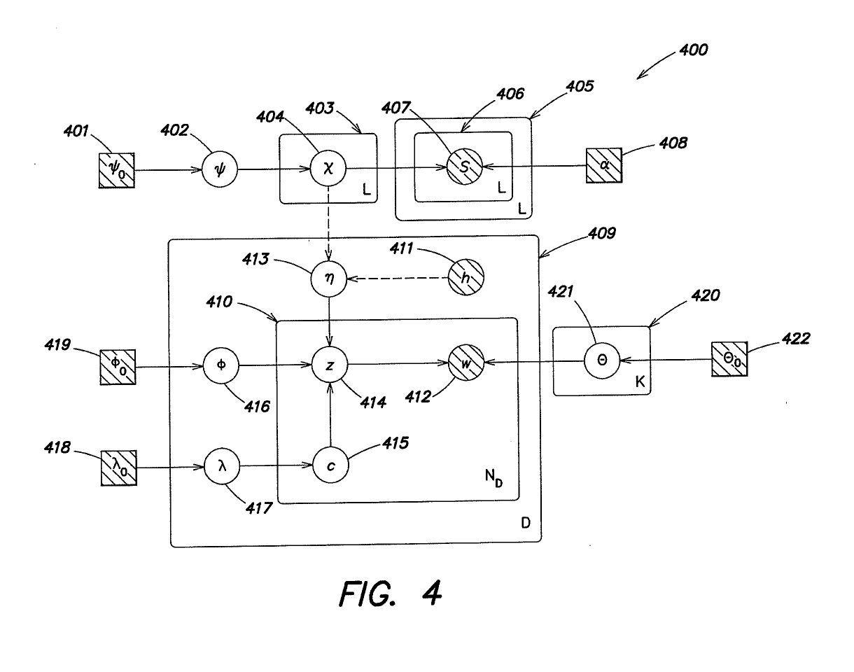

FIG. 4 shows the plate diagram 400 of some embodiments of the model. Shaded circles denote observed variables, and squares denote hyper-parameters. The dotted arrows indicate that η is constructed deterministically from x and h. ε refers to a small constant probability mass. In FIG. 4:

| | |
|---|---|
| ψ 401 represents a keyphrase | ψ: Dirichlet(ψ₀); |
| cluster model and | |
| xₗ 404 represents a | xₗ: Multinomial(ψ); |
| keyphrase cluster assignment | |
| and | |
| s_{l,l′} 407 represents keyphrase similarity assignments and | ${s}_{l , {l}^{′}} : \{ \begin{matrix}Beta ( {α}_{=} ) if {x}_{l} = {x}_{{l}^{′}} \\ Beta ( {α}_{\neq } ) otherwise\end{matrix} ;$ |
| h 411 represents document | |
| keyphrases; | |
| η_{d} 413 represents document keyphrase topics and | $\begin{matrix}{η}_{d} = {[ {η}_{d , 1} {…η}_{d , K} ]}^{T} \\ where {η}_{d , k} ∝ \{ \begin{matrix}1 if {x}_{l} = k for any l ε {h}_{d} \\ ɛ otherwise\end{matrix} ;\end{matrix}$ |
| λ 417 represents a probability | λ: Beta(λ₀); |
| of selecting η 413 instead of | |
| φ 416 and | |
| c_{d,n} 415 selects between η | c_{d,n}: Bernoulli(λ); |
| 413 and φ 416 for word | |
| topics and | |
| φ_{d} 416 represents a | φ_{d}: Dirichlet(φ₀); |
| background word topic model | |
| and | |
| z_{d,n} 414 represents a word topic assignment and | ${z}_{d , n} : \{ \begin{matrix}Multinomial ( {η}_{d} ) if {c}_{d , n} = 1 \\ Multinomial ( {ϕ}_{d} ) otherwise\end{matrix} ;$ |
| θₖ 421 represents a language | θₖ: Dirichlet(θ₀); and |
| model of each topic and | |
| w_{d,n} 412 represents | w_{d,n}: Multinomial(θ_{z}_{_{d,n}}). |
| document words and | |

Embodiments may include a generative Bayesian model for documents annotated with free-text keyphrases. Embodiments may assume that each annotated document is generated from a set of underlying semantic topics. Semantic topics may generate the document text by indexing a language model, which may be a probability distribution over words; in embodiments of the approach described herein, they may also correspond to clusters of keyphrases. In this way, the model can be viewed as an extension of Latent Dirichlet Allocation, where the latent topics are additionally biased toward the keyphrases that appear in the training data. However, this coupling is flexible, as some words are permitted to be drawn from topics that are not represented by the keyphrase annotations. This permits the model to learn effectively in the presence of incomplete annotations, while still encouraging the keyphrase clustering to cohere with the topics supported by the document text.

Another benefit of some embodiments is the ability to use arbitrary comparisons between keyphrases. To accommodate this goal, the system may not treat the keyphrase surface forms as generated from the model. Rather, the system may acquire a real-valued similarity matrix across the universe of possible keyphrases, and treat this matrix as generated from the keyphrase clustering. The permits the use of surface and distributional features for keyphrase similarity, as described in Section 4.1.

An advantage of hierarchical Bayesian models is that it is easy to change which parts of the model are observed and hidden. During training, the keyphrase annotations are observed, so that the hidden semantic topics are coupled with clusters of keyphrases. At test time, the model may be presented with documents for which the keyphrase annotations are hidden. The model may be evaluated on its ability to determine which keyphrases are applicable, based on the hidden topics present in the document text.

The judgment of whether a topic applies to a given unannotated document may be based on the probability mass assigned to that topic in the document's background topic distribution. Because there are no annotations, the background topic distribution should capture the entirety of the document's topics. For the task involving reviews of products and services, multiple topics may accompany each document. In this case, each topic whose probability is above a threshold (tuned on the development set) may be predicted as being supported.

TABLE 2
The two sources of information used to compute the similarity matrix
for the experiments. The final similarity scores are linear
combinations of these two values.

| | |
|---|---|
| Lexical | The cosine similarity between the surface forms of two |
| | keyphrases, represented as word frequency vectors. |
| Co-occurrence | Each keyphrase is represented as a vector of |
| | co-occurrence values. This vector counts how many |
| | times other keyphrases appear in the text of documents |
| | annotated with this keyphrase. For example, the |
| | similarity vector for “good food” may include |
| | an entry for “very tasty food” - the value would be |
| | the number of documents annotated with “good food” |
| | that contain “very tasty food” in their text. The similarity |
| | between two keyphrases is then the cosine similarity of |
| | their co-occurrence vectors. |

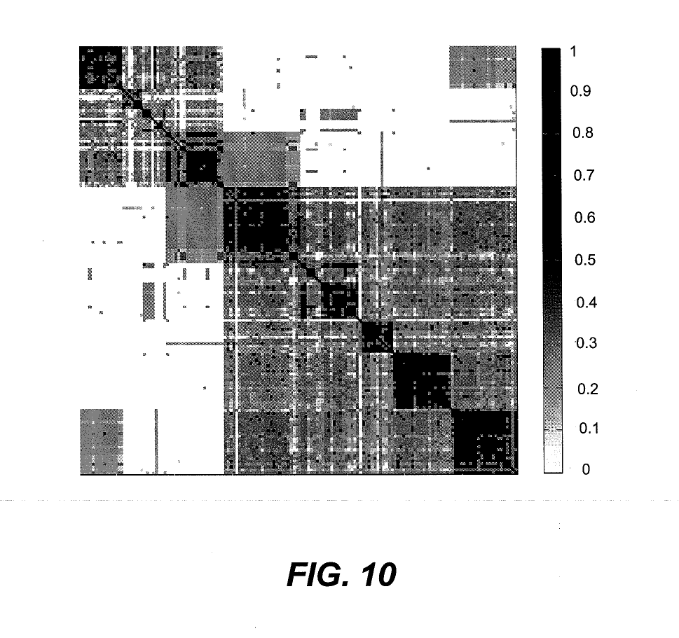

FIG. 10 shows a keyphrase similarity matrix from a set of restaurant reviews, computed according to Table 2. Black areas indicate high similarity, whereas white indicates low similarity. In FIG. 10, the ordering of keyphrases has been grouped according to an expert-created clustering, so keyphrases of similar meaning are close together. The strong series of similarity “blocks” along the diagonal hint at how this information could induce a reasonable clustering.

4.1 Keyphrase Clustering

To handle the hidden paraphrase structure of the keyphrases, in some embodiments, one component of the model estimates a clustering over keyphrases. The goal may be to obtain clusters that each correspond to a well-defined semantic topic—e.g., both “healthy” and “good nutrition” could be grouped into a single cluster. Because the overall joint model is generative, a generative model for clustering would easily be integrated into the larger framework. Such an approach could treat all of the keyphrases in each cluster as generated from a parametric distribution. However, such an approach may not permit many features for assessing the similarity of pairs of keyphrases, such as string overlap.

For this reason, embodiments may represent each keyphrase as a real-valued vector rather than in its surface form. The vector for a given keyphrase may include the similarity scores with respect to every other observed keyphrase (the similarity scores are represented by s in FIG. 4). Embodiments may model these similarity scores as generated by the cluster memberships (represented by x in FIG. 4). If two keyphrases are clustered together, their similarity score may be generated from a distribution encouraging high similarity; otherwise, a distribution encouraging low similarity may be used.

The features used for producing the similarity matrix are given in Table 2, encompassing lexical and distributional similarity measures. One embodiment takes a linear combination of these two data sources. The resulting similarity matrix for keyphrases from restaurant reviews is shown in FIG. 10.

4.2 Document Topic Modeling

Analysis of the document text may be based on probabilistic topic models such as LDA [4]. In the LDA framework, each word may be generated from a language model that is indexed by the word's topic assignment. Thus, rather than identifying a single topic for a document, LDA may identify a distribution over topics. High probability topic assignments will identify compact, low-entropy language models, so that the probability mass of the language model for each topic may be divided among a relatively small vocabulary.

Embodiments operate similarly, identifying a topic for each word, denoted by z in FIG. 4. However, where LDA learns a distribution over topics for each document, the system may deterministically construct a document-specific topic distribution from the clusters represented by the document's keyphrases—this is η 413 in the figure. η 413 may assign equal probability to all topics that are represented in the keyphrase annotations, and very small probability to other topics. Generating the word topics in this way may tie together the clustering and language models.

As noted above, sometimes the keyphrase annotation may not represent all of the semantic topics that are expressed in the text. For this reason, the system may also construct another “background” distribution φ 416 over topics. The auxiliary variable c 415 indicates whether a given word's topic is drawn from the distribution derived the annotations, or from the background model. Representing c 415 as a hidden variable may allow the system to stochastically interpolate between the two language models φ 416 and η 413.

4.3 Generative Process

This section gives a more formal description of the generative process encoded by embodiments of the model.

First, consider the set of all keyphrases observed across the entire corpus, of which there are L. The system may draw a multinomial distribution ψ 1402 over the K keyphrase clusters from a symmetric Dirichlet prior Ψ₀ 401. Then for the l^{th} keyphrase, a cluster assignment Xₗ 404 may be drawn from the multinomial ψ 402. Next, the similarity matrix Sε[0,1]^{L×L} 407 may be constructed. Each entry S_{l,l′} 407 may be drawn independently, depending on the cluster assignments xₗ 404 and X_{l′} 404. Specifically, S_{l,l′} 407 may be drawn from a Beta distribution with parameters α₌ if Xₗ=X_{l′}, and α_{≠} otherwise. The parameters α₌ 408 may linearly bias S_{l,l′} 407 towards one, i.e., Beta(α₌)≡Beta(2,1), and the parameters α_{≠} may linearly bias S_{l,l′} 407 towards zero, i.e., Beta(α_{≠})≡Beta(1,2).

Next, the words in each of the D documents may be generated. Document d has N_{d} words; the topic for word W_{d,n} 412 may be denoted by Z_{d,n} 414. These latent topics may be drawn either uniformly from the set of clusters represented in the document's keyphrases, or from a background topic model φ 416. The system may deterministically construct a document-specific annotation topic model η 413, based on the keyphrase cluster assignments x 404 and the observed keyphrase annotations h 411. The multinomial η_{d} 413 may assign equal probability to each topic that is represented by a phrase in h_{d} 411, and a very small probability mass to other topics (Making a hard assignment of zero probability to the other topics may create problems for parameter estimation. In some embodiments, a probability of 10⁻⁴ was assigned to all topics not represented by the keyphrase cluster memberships.).

As noted earlier, a document's text may support topics that are not mentioned in its keyphrase annotations. For that reason, the system may draw a background topic multinomial φ_{d} 416 for each document from a symmetric Dirichlet prior φ₀ 419. The binary auxiliary variable C_{d,n} 415 may determine whether the topic of the word W_{d,n} 412 is drawn from the annotation topic model η_{d} 413 or the background model 416 φ_{d}. C_{d,n} 415 is drawn from a weighted coin flip, with probability λ 417; λ 417 is drawn from a Beta distribution with prior λ₀ 418. The system may have Z_{d,n}:η_{d} if C_{d,n}=1, and Z_{d,n}:φ_{d} otherwise. Finally, the word W_{d,n} 412 may be drawn from the multinomial θ_{z}_{_{d,n}}, where Z_{d,n} indexes a topic-specific language model. Each of the K language models θₖ 421 may be drawn from a symmetric Dirichlet prior θ₀ 422.

One of the applications of embodiments descfibed herein is to predict properties of documents not annotated with keyphrases. The system may apply the model to unannotated test documents, and compute a posterior point estimate for the topic distribution φ 416 for each document. Because of the lack of annotations, the system may not have partial observations of the document topics, and φ 416 becomes the only document topic model. For this reason, the calculation of the posterior for φ 461 may be based only on the text component of the model, and c 415 may be set such that word topics are drawn from φ 461. For each topic, if its probability in φ 416 exceeds a certain threshold, that topic may be predicted. This threshold is tuned independently for each topic on a development set. The empirical results in Section 6 are obtained in this manner.

### 5 Parameter Estimation

To make predictions on unseen data, embodiments may need to estimate the parameters of the model. In Bayesian inference, the system may estimate the distribution for each parameter, conditioned on the observed data and priors. In some embodiments, such inference is intractable, but sampling approaches may allow approximately constructed distributions for each parameter of interest.

Gibbs sampling is one sampling technique. Conditional distributions may be computed for each hidden variable, given all the other variables in the model. By repeatedly sampling from these distributions in turn, it is possible to construct a Markov chain whose stationary distribution is the posterior of the model parameters. The use of sampling techniques in NLP has been previously investigated by researchers, including Finkel and Goldwater.

Sampling equations for each of the hidden variables is shown in FIG. 4. The prior over keyphrase clusters ψ 402 may be sampled based on the hyperprior ψ₀ 401 and the keyphrase cluster assignments 404. Consider p(ψ| . . . ) to mean the probability conditioned on all the other variables.

$$p ( ψ \vert … ) ∝ p ( ψ \vert {ψ}_{0} ) p ( x \vert ψ ) , \\ \begin{matrix}= p ( ψ \vert {ψ}_{0} ) {\prod }_{l} p ( {x}_{l} \vert ψ ) \\ = Dirichlet ( ψ ; {ψ}_{0} ) {\prod }_{l} Multinomial ( {x}_{l} ; ψ ) \\ = Dirichlet ( ψ ; {ψ}^{′} ) ,\end{matrix}$$

where Ψ′ᵢ is Ψ₀ count(xₗ=i). This update rule is due to the conjugacy of the multinomial to the Dirichlet distribution. The first line follows from Bayes' rule, and the second line from the conditional independence of similarity scores s 407 given x 404 and α 408, and of word topic assignments z 414 given η 413, ψ 402, and c 415.

Resampling equations for φ_{d} 416 and θₖ 421 can be derived in a similar manner:

p(φ_{d}| . . . )∝Dirichlet(φ_{d};φ_{d}′),

p(θₖ| . . . )∝Dirichlet(θₖ;θ_{k′}),

where φ′_{d,i}=φ₀+count(z_{n,d}=i [symbol] c_{n,d}=0) and θ′_{k,i}=θ₀+Σ_{d} count(w_{n,d}=i [symbol] z_{n,d}=k). In building the counts for φ′ᵢ, the system may consider only cases in which c_{n,d}=0, indicating that the topic Z_{n,d} is indeed drawn from the background topic model φ_{d}. Similarly, when building the counts for θ′ₖ, the system may consider only cases in which the word w_{d,n} is drawn from topic k.

To resample λ 417, the system may employ the conjugacy of the Beta prior to the Bernoulli observation likelihoods, adding counts of c 415 to the prior λ₀ 418.

p(λ| . . . )∝Beta(λ;λ′),

where λ′=λ₀+[1.4 in_dcount(c_d,n=1) _dcount(c_d,n=0)].

The keyphrase cluster assignments are represented by x 404, whose sampling distribution depends on ψ 402, s 407, and z 414, via η 413:

$$p ( {x}_{l} \vert … ) ∝ p ( {x}_{l} \vert ψ ) p ( s \vert {x}_{l} , x {\_}_{l} , α ) p ( z \vert η , ψ , c ) ∝ p ( {x}_{l} \vert ψ ) [ {\prod }_{{l}^{′} \neq l} p ( {s}_{l , {l}^{′}} \vert {x}_{l} , {x}_{{l}^{′}} , α ) ] [ {\prod }_{d}^{D} {\prod }_{{c}_{d , n} = 1} p ( {z}_{d , n} \vert {η}_{d} ) ] = Multinomial ( {x}_{l} ; ψ ) [ {\prod }_{{l}^{′} \neq l} Beta ( {s}_{l , {l}^{′}} ; {α}_{{x}_{l} , {x}_{{l}^{′}}} ) ] [ {\prod }_{d}^{D} {\prod }_{{c}_{d , n} = 1} Multinomial ( {z}_{d , n} ; {η}_{d} ) ] .$$

The leftmost term of the above equation is the prior on Xₗ 404. The next term encodes the dependence of the similarity matrix s 407 on the cluster assignments; with slight abuse of notation, consider αx_{ₗ}_{,x}_{_{l′}} 407 to denote α₌ if xₗ=x_{l′}, and α₌ otherwise. The third term is the dependence of the word topics z_{d,n}, 414 on the topic distribution η_{d} 413. The system may compute the final result of this probability expression for each possible setting of xₗ 404, and then sample from the normalized multinomial.

The word topics z 414 are sampled according to the topic distribution η_{d} 413, the background distribution φ_{d} 416, the observed words w 412, and the auxiliary variable c 415:

$$p ( {z}_{d , n} \vert … ) ∝ p ( {z}_{d , n} \vert ϕ , {η}_{d} , {c}_{d , n} ) p ( {w}_{d , n} \vert {z}_{d , n} , θ ) = \{ \begin{matrix}Multinomial ( {z}_{d , n} ; {η}_{d} ) Multinomial ( {w}_{d , n} ; {θ}_{{z}_{d , n}} ) & if {c}_{d , n} = 1 \\ Multinomial ( {z}_{d , n} ; {ϕ}_{d} ) Multinomial ( {w}_{d , n} ; {θ}_{{z}_{d , n}} ) & otherwise .\end{matrix}$$

As with x 404, each z_{d,n}, 414 may be sampled by computing the conditional likelihood of each possible setting within a constant of proportionality, and then sampling from the normalized multinomial.

Finally, the system may sample the auxiliary variables c_{d,n} 415, which indicates whether the hidden topic Z_{d,n} 414 is drawn from η_{d} 413 or φ_{d} 416. c 415 depends on its prior λ 417 and the hidden topic assignments z 414:

$$p ( {c}_{d , n} \vert … ) ∝ p ( {c}_{d , n} \vert λ ) p ( {z}_{d , n} \vert {η}_{d} , {φ}_{d} , {c}_{d , n} ) = \{ \begin{matrix}Bernoulli ( {c}_{d , n} ; λ ) Multinomial ( {z}_{d , n} ; {η}_{d} ) & if {c}_{d , n} = 1 \\ Bernoulli ( {c}_{d , n} ; λ ) Multinomial ( {z}_{d , n} ; {ϕ}_{d} ) & otherwise .\end{matrix}$$

Again, the system may compute the likelihood of c_{d,n}=0 and c_{d,n}=1 within a constant of proportionality, and then sample from the normalized Bernoulli distribution.

At test time, the system could compute a posterior estimate for φ_{d} 416 for an unannotated document d. For this estimate, the system may use the same Gibbs sampling procedure, restricted to Z_{d,n} 414 and φ_{d} 416, with the stipulation that C_{d,n} 415 is always zero. In particular, the system may treat the language models as known; to more accurately integrate over all possible language models, the system may use samples of the language models from training as opposed to a point estimate.

### 6 Evaluation of Summarization Quality

Embodiments of the model for document analysis are implemented in Précis, a system that performs single- and multi-document review summarization. One goal of Précis is to provide users with effective access to review data via mobile devices. Précis contains information about 49,490 products and services ranging from childcare products to restaurants and movies. For each of these products, the system contains a collection of reviews downloaded from consumer websites such as Epinions, CNET, and Amazon. Précis compresses data for each product into a short list of pros and cons that are supported by the majority of reviews. An example of a summary of 27 reviews 500 for the movie Pirates of the Caribbean: At World's End 501 is shown in FIG. 5. In contrast to traditional multidocument summarizers, the output of the system 500 may not be a sequence of sentences, but rather a list of phrases indicative of product properties. This summarization format follows the format of pro/con summaries 504 that individual reviewers provide on multiple consumer websites. Moreover, the brevity of the summary 500 is particularly suitable for presenting on small screens such as those of mobile devices.

To automatically generate the combined pro/con list 504 for a product or service, embodiments of the system may first apply the model to each review. The model may be trained independently for each product domain (e.g., movies) using a corresponding subset of reviews with free-text annotations. These annotations may also provide a set of keyphrases that contribute to the clusters associated with product properties. Once the model is trained, it may label each review with a set of properties. Since the set of possible properties may be the same for all reviews of a product, the comparison among reviews is straightforward—for each property, the system may count the number of reviews that support it, and select the property as part of a summary if it is supported by the majority of the reviews. The set of semantic properties may be converted into a pro/con list by presenting the most common keyphrase for each property.

This aggregation technology may be applicable in two scenarios. The system can be applied to unannotated reviews, inducing semantic properties from the document text; this conforms to the traditional way in which learning-based systems are applied to unlabeled data. However, the model is valuable even when individual reviews do include pro/con keyphrase annotations. Due to the high degree of paraphrasing, direct comparison of keyphrases may be challenging (see Section 3). By inferring a clustering over keyphrases, the model may permit comparison of keyphrase annotations on a more semantic level.

The remainder of this section provides a set of intrinsic evaluations of the model's ability to capture the semantic content of document text and keyphrase annotations. Section 6.1 describes an evaluation of the system's ability to extract meaningful semantic summaries from individual documents, and also assesses the quality of the paraphrase structure induced by the model. Section 6.2 extends this evaluation to the system's ability to summarize multiple review documents.

6.1 Single-Document Evaluation

First, embodiments of the system may evaluate the model with respect to its ability to reproduce the annotations present in individual documents, based on the document text. The system may compare against a wide variety of baselines and variations of the model, demonstrating the appropriateness of the approach for this task. In addition, the system may explicitly evaluate the compatibility of the paraphrase structure induced by the model by comparing against a gold standard clustering of keyphrases provided by expert annotators.

6.1.1 Experimental Setup

In this section, the datasets and evaluation techniques used for experiments with the system and other automatic methods are described. This section also comments on how hyper-parameters are tuned for the model, and how sampling is initialized.

TABLE 4
Statistics of the datasets used in the evaluations

| Statistic | Restaurants | Cell Phones | Digital Cameras |
|---|---|---|---|
| # of reviews | 5735 | 1112 | 3971 |
| avg. review length | 786.3 | 1056.9 | 1014.2 |
| avg. keyphrases/review | 3.42 | 4.91 | 4.84 |

Data Sets. This section evaluates the system on reviews from three domains: restaurants, cell phones, and digital cameras. These reviews were downloaded from the Epinions website, which had used user-authored pros and cons associated with reviews as keyphrases (see Section 3). Statistics for the datasets are provided in Table 4. For each of the domains, the system selected 50% of the documents for training.

Two strategies may be used for constructing test data. First, the system may consider evaluating the semantic properties inferred by the system against expert annotations of the semantic properties present in each document. To this end, the system may use the expert annotations originally described in Section 3 as a test set; to reiterate, these were annotations on 170 reviews in the restaurant domain, of which 50 are used as a development set. These review texts were annotated with six properties according to standardized annotation guidelines. This strategy enforces consistency and completeness in the resulting annotation, differentiating them from free-text annotations.

Unfortunately, the ability to evaluate against expert annotations is limited by the cost of producing such annotations. To expand evaluation to other domains, one may use the author-written keyphrase annotations that are present in the original reviews. Such annotations are noisy—while the presence of a property annotation on a document is strong evidence that the document supports the property, the inverse is not necessarily true. That is, the lack of an annotation does not necessarily imply that its respective property does not hold—e.g., a review with no good service-related keyphrase may still praise the service in the body of the document.

For experiments using free-text annotations, one may overcome this pitfall by restricting the evaluation of predictions of individual properties to only those documents that are annotated with that property or its antonym. For instance, when evaluating the prediction of the good service property, one may only select documents which are either annotated with good service or bad service-related keyphrases (This determination may be made by mapping author keyphrases to properties using an expert-generated gold standard clustering of keyphrases. It may be cheaper to produce an expert clustering of keyphrases than to obtain expert annotations of the semantic properties in every document.). For this reason, each semantic property may be evaluated against a unique subset of documents. The details of these development and test sets are presented in Section 7.

To ensure that free-text annotations can be reliably used for evaluation, one may compare with the results produced on expert annotations whenever possible. As shown in Section 6.1.2, the free-text evaluations may produce results that cohere well with those obtained on expert annotations, suggesting that such labels can be used as a reasonable proxy for expert annotation evaluations.

Evaluation Methods. The first evaluation leverages the expert annotations described in Section 3. One complication is that expert annotations are marked on the level of semantic properties, while the model makes predictions about the appropriateness of individual keyphrases. One may address this by representing each expert annotation with the most commonly-observed keyphrase from the manually-annotated cluster of keyphrases associated with the semantic property. For example, an annotation of the semantic property good food is represented with its most common keyphrase realization, “great food.” The evaluation then checks whether this keyphrase is within any of the clusters of keyphrases predicted by the model.

The evaluation against author free-text annotations may be similar to the evaluation against expert annotations. In this case, the annotation may take the form of individual keyphrases rather than semantic properties. As noted, author-generated keyphrases suffer from inconsistency. The system may obtain a consistent evaluation by mapping the author-generated keyphrase to a cluster of keyphrases as a determined by the expert annotator, and then again selecting the most common keyphrase realization of the cluster. For example, the author may use the keyphrase “tasty,” which maps to the semantic cluster good food; the system may then select the most common keyphrase realization, “great food.” As in the expert evaluation, one may check whether this keyphrase is within any of the clusters predicted by the model.

Model performance may be quantified using recall, precision, and F-score. These may be computed in the standard manner, based on the model's representative keyphrase predictions compared against the corresponding references. Approximate randomization was used for statistical significance testing. One may use this test because it is valid for comparing nonlinear functions of random variables, such as F-scores, unlike other common methods such as the sign test.

Parameter Tuning and Initialization. To improve the model's convergence rate, one may perform two initialization steps for the Gibbs sampler. First, sampling may be done only on the keyphrase clustering component of the model, ignoring document text. Second, the system may fix this clustering and sample the remaining model parameters.

These two steps are run for 5,000 iterations each. The full joint model is then sampled for 100,000 iterations. Inspection of the parameter estimates confirms model convergence. On a 2 GHz dual-core desktop machine, a multithreaded C++ implementation of model training takes about two hours for each dataset.

The model may be provided with the number of clusters K. One may set K large enough for the model to learn effectively on the development set. For the restaurant data the system may set K to 20. For cell phones and digital cameras, K was set to 30 and 40, respectively. In general, as long as K is sufficiently large, varying K does not affect the model's performance.

As previously mentioned, one may obtain document properties by examining the probability mass of the topic distribution assigned to each property. A probability threshold may be set for each property via the development set, optimizing for maximum F-score. The point estimate used for the topic distribution itself may be an average over the last 1,000 Gibbs sampling iterations. Averaging is a heuristic that may be applicable because sample histograms may be unimodal and exhibit low skew.

TABLE 5
A summary of the baselines and variations against which the model is
compared.

| | |
|---|---|
| Random | Each keyphrase is supported by a document with probability of one half. |
| Keyphrase in | A keyphrase is supported by a document if it appears verbatim in the text. |
| text | |
| Keyphrase | A separate support vector machine classifier is trained for each keyphrase. |
| classifier | Positive examples are documents that are labeled by the author with the |
| | keyphrase; all other documents are considered to be negative examples. A |
| | keyphrase is supported by a document if that keyphrase's classifier returns |
| | a positive prediction. |
| Model | A keyphrase is supported by a document if it or any of its paraphrases |
| cluster in | appear in the text. Paraphrasing is based on the model's clustering of the |
| text | keyphrases. |
| Model | A separate support vector machine classifier is trained for each cluster of |
| cluster | keyphrases. Positive examples are documents that are labeled by the |
| classifier | author with any keyphrase from the cluster; all other documents are |
| | negative examples. All keyphrases of a cluster are supported by a |
| | document if that cluster's classifier returns a positive prediction. |
| | Keyphrase clustering is based on the model. |
| Gold cluster | A variation of the model where the clustering of keyphrases is fixed to an |
| model | expert-created gold standard. Only the text modeling parameters are |
| | learned. |
| Gold cluster | Similar to model cluster in text, except the clustering of keyphrases is |
| in text | according to the expert-produced gold standard. |
| Gold cluster | Similar to model cluster classifier, except the clustering of keyphrases is |
| classifier | according to the expert-produced gold standard. |
| Independent | A variation of the model where the clustering of keyphrases is first |
| cluster | learned from keyphrase similarity information only, separately from the |
| model | text. The resulting independent clustering is then fixed while the text |
| | modeling parameters are learned. This variation's key distinction from the |
| | full model is the lack of joint learning of keyphrase clustering and text |
| | topics. |
| Independent | Similar to model cluster in text, except that the clustering of keyphrases is |
| cluster in | according to the independent clustering. |
| text | |
| Independent | Similar to model cluster classifier, except that the clustering of |
| cluster | keyphrases is according to the independent clustering. |
| classifier | |

TABLE 6
Comparison of the property predictions made by the model and a series
of baselines and model variations in the restaurant domain, evaluated
against expert semantic annotations.

| | | Restaurants | | |
|---|---|---|---|---|
| | Method | Recall | Prec. | F-score |
| 1 | Model described herein | 0.920 | 0.353 | 0.510 |
| 2 | Random | 0.500 | 0.346 | 0.409* |
| 3 | Keyphrase in text | 0.048 | 0.500 | 0.087* |
| 4 | Keyphrase classifier | 0.769 | 0.353 | 0.484* |
| 5 | Model cluster in text | 0.227 | 0.385 | 0.286* |
| 6 | Model cluster classifier | 0.721 | 0.402 | 0.516 |
| 7 | Gold cluster model | 0.936 | 0.344 | 0.502 |
| 8 | Gold cluster in text | 0.339 | 0.360 | 0.349* |
| 9 | Gold cluster classifier | 0.693 | 0.366 | 0.479* |
| 10 | Indep. cluster model | 0.745 | 0.363 | 0.488⋄ |
| 11 | Indep. cluster in text | 0.220 | 0.340 | 0.266* |
| 12 | Indep. cluster classifier | 0.586 | 0.384 | 0.464* |

The results are divided according to experiment. The methods against which the model has significantly better results using approximate randomization are indicated with * for p ≦ 0.05, and ⋄ for p ≦ 0.1.

TABLE 7
Comparison of the property predictions made by the model and a series of
baselines and model variations in three product domains, as evaluated against author
free-text annotations.

| | | | | | | | | Digital | | |
|---|---|---|---|---|---|---|---|---|---|---|
| | | Restaurants | | | Cell Phones | | | Cameras | | |
| | | | | F- | | | F- | | | F- |
| | Method | Recall | Prec. | score | Recall | Prec. | score | Recall | Prec. | score |
| 1 | Model | 0.923 | 0.623 | 0.744 | 0.971 | 0.537 | 0.692 | 0.905 | 0.586 | 0.711 |
| | described | | | | | | | | | |
| | herein | | | | | | | | | |
| 2 | Random | 0.500 | 0.500 | 0.500* | 0.500 | 0.489 | 0.494* | 0.500 | 0.501 | 0.500* |
| 3 | Keyphrase | 0.077 | 0.906 | 0.142* | 0.171 | 0.529 | 0.259* | 0.715 | 0.642 | 0.676* |
| | in text | | | | | | | | | |
| 4 | Keyphrase | 0.905 | 0.527 | 0.666* | 1.000 | 0.500 | 0.667 | 0.942 | 0.540 | 0.687⋄ |
| | classifier | | | | | | | | | |
| 5 | Model | 0.416 | 0.613 | 0.496* | 0.829 | 0.547 | 0.659⋄ | 0.812 | 0.596 | 0.687* |
| | cluster in | | | | | | | | | |
| | text | | | | | | | | | |
| 6 | Model | 0.859 | 0.711 | 0.778† | 0.876 | 0.561 | 0.684 | 0.927 | 0.568 | 0.704 |
| | cluster | | | | | | | | | |
| | classifier | | | | | | | | | |
| 7 | Gold | 0.992 | 0.500 | 0.665* | 0.924 | 0.561 | 0.698 | 0.962 | 0.510 | 0.667* |
| | cluster | | | | | | | | | |
| | model | | | | | | | | | |
| 8 | Gold | 0.541 | 0.604 | 0.571* | 0.914 | 0.497 | 0.644* | 0.903 | 0.522 | 0.661* |
| | cluster in | | | | | | | | | |
| | text | | | | | | | | | |
| 9 | Gold | 0.865 | 0.720 | 0.786† | 0.810 | 0.559 | 0.661 | 0.874 | 0.674 | 0.761 |
| | cluster | | | | | | | | | |
| | classifier | | | | | | | | | |
| 10 | Indep. | 0.984 | 0.528 | 0.687* | 0.838 | 0.564 | 0.674 | 0.945 | 0.519 | 0.670* |
| | cluster | | | | | | | | | |
| | model | | | | | | | | | |
| 11 | Indep. | 0.382 | 0.569 | 0.457* | 0.724 | 0.481 | 0.578* | 0.469 | 0.476 | 0.473* |
| | cluster in | | | | | | | | | |
| | text | | | | | | | | | |
| 12 | Indep. | 0.753 | 0.696 | 0.724 | 0.638 | 0.472 | 0.543* | 0.496 | 0.588 | 0.538* |
| | cluster | | | | | | | | | |
| | classifier | | | | | | | | | |

The results are divided according to experiment.
The methods against which the model has significantly better results using approximate randomization are indicated with * for p ≦ 0.05, and ⋄ for p ≦ 0.1.
Methods which perform significantly better than the model with p ≦ 0.05 are indicated with †.

6.1.2 Results

This section describes the performance of the model, comparing it with an array of increasingly sophisticated baselines and model variations. First, a clustering of annotation keyphrases may be important for accurate semantic prediction. Next, the impact of paraphrasing quality on model accuracy is evaluated by considering the expert-generated gold standard clustering of keyphrases as another comparison point; alternative automatically computed sources of paraphrase information are also considered.

For ease of comparison, the results of all the experiments are shown in Table 6 and Table 7, with a summary of the baselines and model variations in Table 5 (Note that the classifier results reported in the initial publication were obtained using the default parameters of a maximum entropy classifier.).

Comparison against Simple Baselines. The first evaluation compares the model to three naïve baselines. All three treat keyphrases as independent, ignoring their latent paraphrase structure.
Random: Each keyphrase is supported by a document with probability of one half. The results of this baseline are computed in expectation, rather than actually run. This baseline is expected to have a recall of 0.5, because in expectation it will select half of the correct keyphrases. Its precision is the average proportion of annotations in the test set against the number of possible annotations. That is, in a test set of size n with m properties, if property i appears nᵢ times, then expected precision is Σᵢ₌₁^{m}nᵢ/mn. For instance, for the restaurants gold standard evaluation, the six tested properties appeared a total of 249 times over 120 documents, yielding an expected precision of 0.346.
Keyphrase in text: A keyphrase is supported by a document if it appears verbatim in the text. Precision should be high while recall will be low, because the model is unable to detect paraphrases of the keyphrase in the text. For instance, for the first review from FIG. 1, “cleanliness” would be supported because it appears in the text; however, “healthy” would not be supported, even though the synonymous “great nutrition” does appear.
Keyphrase classifier: A separate discriminative classifier is trained for each keyphrase. Positive examples are documents that are labeled by the author with the keyphrase; all other documents are considered to be negative examples. Consequently, for any particular keyphrase, documents labeled with synonymous keyphrases would be among the negative examples. A keyphrase is supported by a document if that keyphrase's classifier returns a positive prediction.

One may use support vector machines, built using SVM light with the same features as the embodiment of the model discussed above, i.e., word counts. To partially circumvent the imbalanced positive/negative data problem, one may tune prediction thresholds on a development set in the same manner the system can tune thresholds for the model, to maximize F-score.

Lines 2-4 of Tables 9 and 10 present these results, using both gold annotations and the original authors' annotations for testing. The model outperforms these three baselines in all evaluations with strong statistical significance.

The keyphrase in text baseline fares poorly: its F-score is below the random baseline in three of the four evaluations. As expected, the recall of this baseline is usually low because it requires keyphrases to appear verbatim in the text. The precision is somewhat better, but the presence of a significant number of false positives indicates that the presence of a keyphrase in the text is not necessarily a reliable indicator of the associated semantic property.

Interestingly, one domain in which keyphrase in text does perform well is digital cameras. This may be because of the prevalence of specific technical terms in the keyphrases used in this domain, such as “zoom” and “battery life.” Such technical terms are also frequently used in the review text, making the recall of keyphrase in text substantially higher in this domain than in the other evaluations.

The keyphrase classifier baseline outperforms the random and keyphrase in text baselines, but still achieves consistently lower performance than the model in all four evaluations. Overall, these results indicate that methods which learn and predict keyphrases without accounting for their intrinsic hidden structure are insufficient for optimal property prediction. This leads us toward extending the present baselines with clustering information.

One may assess the consistency of the evaluation based on free-text annotations (Table 7) with the evaluation that uses expert annotations (Table 6). While the absolute scores on the expert annotations dataset are lower than the scores with free-text annotations, the ordering of performance between the various automatic methods is the same across the two evaluation scenarios. This consistency is maintained in the rest of the experiments as well, indicating that for the purpose of relative comparison between the different automatic methods, the method of evaluating with free-text annotations may be a reasonable proxy for evaluation on expert-generated annotations.

Comparison against Clustered Approaches. The previous section demonstrates that the model outperforms baselines that do not account for the paraphrase structure of keyphrases. The baseline' performance may be enhanced by augmenting with the keyphrase clustering induced by the model. Specifically, consider two more systems, neither of which are “true” baselines, since they both use information inferred by the model.
Model cluster in text: A keyphrase is supported by a document if it or any of its paraphrases appears in the text. Paraphrasing is based on the model's clustering of the keyphrases. The use of paraphrasing information enhances recall at the potential cost of precision, depending on the quality of the clustering. For example, assuming “healthy” and “great nutrition” are clustered together, the presence of “healthy” in the text would also indicate support for “great nutrition,” and vice versa.
Model cluster classifier: A separate discriminative classifier is trained for each cluster of keyphrases. Positive examples are documents that are labeled by the author with any keyphrase from the cluster; all other documents are negative examples. All keyphrases of a cluster are supported by a document if that cluster's classifier returns a positive prediction. Keyphrase clustering is based on the model. As with keyphrase classifier, the system may use support vector machines trained on word count features, and the system may tune the prediction thresholds for each individual cluster on a development set.

Another perspective on model cluster classifier is that it augments the simplistic text modeling portion of the model with a discriminative classifier. Discriminative training is often considered to be more powerful than equivalent generative approaches, leading us to expect a high level of performance from this system. However, the generative approach has the advantage of performing clustering and learning in a joint framework.

Lines 5-6 of Tables 9 and 10 present results for these two methods. Using a clustering of keyphrases with the baseline methods improves their recall, with low impact on precision. Model cluster in text invariably outperforms keyphrase in text—the recall of keyphrase in text is improved by the addition of clustering information, though precision is worse in some cases. This phenomenon holds even in the digital cameras domain, where keyphrase in text already performs respectably. However, the model still significantly outperforms model cluster in text in all evaluations.

Adding clustering information to the classifier baseline results in performance that is sometimes better than the model's. This result is not surprising, because model cluster classifier gains the benefit of the model's robust clustering while learning a more sophisticated classifier for assigning properties to texts. The resulting combined system is more complex than the model by itself, but has the potential to yield better performance.

Overall, the enhanced performance of these two methods, in contast to the keyphrase baselines, is aligned with previous observations in entailment research, confirming that paraphrasing information contributes greatly to improved performance in semantic inference tasks.

The Impact of Paraphrasing Quality. The previous section demonstrates that accounting for paraphrase structure may yield substantial improvements in semantic inference when using noisy keyphrase annotations. A second aspect is the idea that clustering quality may benefit from tying the clusters to hidden topics in the document text. This claim can be evaluated by comparing the model's clustering against an independent clustering baseline. The system can also be compared against a “gold standard” clustering produced by expert human annotators. To test the impact of these clustering methods, one could substitute the model's inferred clustering with each alternative and examine how the resulting semantic inferences change. This comparison is performed for the semantic inference mechanism of the model, as well as for the model cluster in text and model cluster classifier baseline approaches.

To add a “gold standard” clustering to the model, once could replace the hidden variables that correspond to keyphrase clusters with observed values that are set according to the gold standard clustering. The parameters that are trained are those for modeling review text. This model variation—gold cluster model—predicts properties using the same inference mechanism as the original model. The baseline variations gold cluster in text and gold cluster classifier are likewise derived by substituting the automatically computed clustering with gold standard clusters.

An additional clustering may be obtained using only the keyphrase similarity information. Specifically, the original model may be modified so that it learns the keyphrase clustering in isolation from the text, and only then learns the property language models. In this framework, the keyphrase clustering may be entirely independent of the review text, because the text modeling is learned with the keyphrase clustering fixed. This modification of the model may be described as an independent cluster model. Because the model treats the document text as a mixture of latent topics, this is equivalent to running supervised latent Dirichlet allocation, with the labels acquired by performing a clustering across keyphrases as a preprocessing step. As in the previous experiment, the system may introduce two new baseline variations—independent cluster in text and independent cluster classifier.

Lines 7-12 of Tables 9 and 10 present the results of these experiments. The gold cluster model produces F-scores comparable to the original model, providing strong evidence that the clustering induced by the model is of sufficient quality for semantic inference. The application of the expert-generated clustering to the baselines (lines 8 and 9) yields less consistent results, but overall this evaluation provides little reason to believe that performance would be substantially improved by obtaining a clustering that was closer to the gold standard.

The independent cluster model consistently reduces performance with respect to the full joint model, supporting a hypothesis that joint learning gives rise to better prediction. The independent clustering baselines, independent cluster in text and independent cluster classifier (lines 11 and 12), are also consistently worse than their counterparts that use the model clustering (lines 5 and 6). From this observation, one can conclude that while the expert-annotated clustering does not always improve results, the independent clustering always degrades them. This supports the view that joint learning of clustering and text models may be an important prerequisite for better property prediction.

TABLE 8
Rand Index scores of the model's clusters, learned from keyphrases
and text jointly, compared against clusters learned only from
keyphrase similarity. Evaluation of cluster quality is based on
the gold standard clustering.

| | | Cell | Digital |
|---|---|---|---|
| Clustering | Restaurants | Phones | Cameras |
| Model | 0.914 | 0.876 | 0.945 |
| clusters | | | |
| Independent | 0.892 | 0.759 | 0.921 |
| clusters | | | |

Another way of assessing the quality of each automatically-obtained keyphrase clustering is to quantify its similarity to the clustering produced by the expert annotators. For this purpose one can use the Rand Index, a measure of cluster similarity. This measure varies from zero to one, with higher scores indicating greater similarity. Table 8 shows the Rand Index scores for the model's full joint clustering, as well as the clustering obtained from independent cluster model. In every domain, joint inference produces an overall clustering that improves upon the keyphrase-similarity-only approach. These scores again confirm that joint inference across keyphrases and document text produces a better clustering than considering features of the keyphrases alone.

6.2 Summarizing Multiple Reviews

Other embodiments of the invention relate to multidocument summarization. The model may be able to aggregate properties across a set of reviews, compared to baselines that aggregate by directly using the free-text annotations.

6.2.1 Data and Evaluation

The data consisted of 50 restaurants, with five user-written reviews for each restaurant. Ten annotators were asked to annotate the reviews for five restaurants each, comprising 25 reviews per annotator. They used the same six salient properties and the same annotation guidelines as in the previous restaurant annotation experiment (see Section 3). In constructing the ground truth, properties that are supported in at least three of the five reviews are labeled.

Property predictions on the same set of reviews with the model and a series of baselines are presented below. For the automatic methods, a prediction is registered if property is supported on at least two of the five reviews (When three corroborating reviews are required, the baseline systems produce very few positive predictions, leading to poor recall. Results for this setting are presented in Section 8.). The recall, precision, and F-score are computed over these aggregate predictions, against the six salient properties marked by annotators.

Systems. In this evaluation, the trained version of the model may be used as described in Section 6.1.1. Note that keyphrases are not provided to the model, though they are provided to the baseline systems.

The most obvious baseline for summarizing multiple reviews would be to directly aggregate their free-text keyphrases. These annotations are presumably representative of the review's semantic properties, and unlike the review text, keyphrases can be matched directly with each other. The first baseline applies this notion directly:
Keyphrase aggregation: A keyphrase is supported for a restaurant if at least two out of its five reviews are annotated verbatim with that keyphrase.

This simple aggregation approach has the downside of requiring very strict matching between independently authored reviews. For that reason, extensions to this aggregation approach may be considered that allow for annotation paraphrasing:
Model cluster aggregation: A keyphrase is supported for a restaurant if at least two out of its five reviews are annotated with that keyphrase or one of its paraphrases. Paraphrasing is according to the model's inferred clustering.
Gold cluster aggregation: Same as model cluster aggregation, but using the expert-generated clustering for paraphrasing.
Independent cluster aggregation: Same as model cluster aggregation, but using the clustering learned only from keyphrase similarity for aggregation.

TABLE 9
Comparison of the aggregated property predictions made by the
model and a series of baselines that use free-text annotations.

| Method | Recall | Prec. | F-score |
|---|---|---|---|
| Model | 0.905 | 0.325 | 0.478 |
| described | | | |
| herein | | | |
| Keyphrase | 0.036 | 0.750 | 0.068* |
| aggregation | | | |
| Model cluster | 0.238 | 0.870 | 0.374* |
| aggregation | | | |
| Gold cluster | 0.226 | 0.826 | 0.355* |
| aggregation | | | |
| Indep. cluster | 0.214 | 0.720 | 0.330* |
| aggregation | | | |

The methods against which the model has significantly better results using approximate randomization are indicated with * for p ≦ 0.05.

6.2.2 Results

Table 9 compares the baselines against embodiments of the model. The model outperforms all of the annotation-based baselines, despite not having access to the keyphrase annotations. Notably, keyphrase aggregation performs very poorly, because it makes very few predictions, as a result of its requirement of exact keyphrase string match. As before, the inclusion of keyphrase clusters improves the performance of the baseline models. However, the incompleteness of the keyphrase annotations (see Section 3) explains why the recall scores are still low compared to the model. By incorporating document text, the model obtains dramatically improved recall, at the cost of reduced precision, ultimately yielding a significantly improved F-score.

These results demonstrate that review summarization benefits greatly from the joint model of the review text and keyphrases. Naïve approaches that consider only keyphrases yield inferior results, even when augmented with paraphrase information.

### 7 Development and Test Set Statistics

Table 10 lists the semantic properties for each domain and the number of documents that are used for evaluating each of these properties. As noted above, the gold standard evaluation is complete, testing every property with each document. Conversely, the free-text evaluations for each property only use documents that are annotated with the property or its antonym—this is why the number of documents differs for each semantic property.

TABLE 10
Breakdown by property for the development and test sets used for the
evaluations in section 6.1.2.

| | | Development | Test |
|---|---|---|---|
| Domain | Property | documents | Documents |
| Restaurants | All properties | 50 | 120 |
| (gold) | | | |
| Restaurants | Good food | 88 | 179 |
| | Bad food | | |
| | Good price | 31 | 66 |
| | Bad price | | |
| | Good service | 69 | 140 |
| | Bad service | | |
| Cell | Good reception | 33 | 67 |
| Phones | Bad reception | | |
| | Good battery life | 59 | 120 |
| | Poor battery life | | |
| | Good price | 28 | 57 |
| | Bad price | | |
| Cameras | Small | 84 | 168 |
| | Large | | |
| | Good price | 56 | 113 |
| | Bad price | | |
| | Good battery life | 51 | 102 |
| | Poor battery life | | |
| | Great zoom | 34 | 69 |
| | Limited zoom | | |

### 8 Additional Multiple Review Summarization Results

Table 11 lists results of the aggregation experiment, with a variation on the evaluation—each automatic method is required to predict a property for three of five reviews to predict that property for the product, rather than two as presented in Section 6.2. For the baseline systems, this change may cause a precipitous drop in recall, leading to F-score results that are substantially worse than those presented in Section 6.2.2. In contrast, the F-score for the model is consistent across both evaluations.

TABLE 11
Comparison of the aggregated property predictions made by the model
and a series of baselines that only use free-text annotations.

| Method | Recall | Prec. | F-score |
|---|---|---|---|
| Model | 0.726 | 0.365 | 0.486 |
| described | | | |
| herein | | | |
| Keyphrase | 0.000 | 0.000 | 0.000* |
| aggregation | | | |
| Model | 0.024 | 1.000 | 0.047* |
| cluster | | | |
| aggregation | | | |
| Gold cluster | 0.036 | 1.000 | 0.068* |
| aggregation | | | |
| Indep. | 0.036 | 1.000 | 0.068* |
| cluster | | | |
| aggregation | | | |

Aggregation requires three of five reviews to predict a property, rather than two as in Section 6.2. The methods against which the model has significantly better results using approximate randomization are indicated with * for p ≦ 0.05.

### 9 Exemplary Implementations

Free-text keyphrase annotations provided by novice users may be leveraged as a training set for document-level semantic inference. Free-text annotations have the potential to vastly expand the set of training data available to developers of semantic inference systems; however, they may suffer from lack of consistency and completeness. Inducing a hidden structure of semantic properties, which correspond both to clusters of keyphrases and hidden topics in the text may overcome these problems. Some embodiments of the invention employ a hierarchical Bayesian model that addresses both the text and keyphrases jointly.

Embodiments of the invention may be implemented in a system that successfully extracts semantic properties of unannotated restaurant, cell phone, and camera reviews, empirically validating the approach. Experiments demonstrate the benefit of handling the paraphrase structure of free-text keyphrase annotations; moreover, they show that a better paraphrase structure is learned in a joint framework that also models the document text. Exemplary embodiments described herein outperform competitive baselines for semantic property extraction from both single and multiple documents and also permit aggregation across multiple keyphrases with different surface forms for multidocument summarization.

Both topic modeling and paraphrasing posit a hidden layer that captures the relationship between disparate surface forms: in topic modeling, there is a set of latent distributions over lexical items, while paraphrasing is represented by a latent clustering over phrases. Embodiments show these two latent structures can be linked, resulting in increased robustness and semantic coherence.

One example of a model that can be used to identify semantic topics in documents in accordance with some embodiments of the invention is shown in FIG. 7. A model that can be used to identify semantic topics in documents 700 may comprise a first sub-model for identifying semantic topics in free-text annotations 701, using any of the techniques discussed above. A model that can be used to identify semantic topics in documents 700 may also comprise a second sub-model for identifying semantic topics in the body of a document 701, using any of the techniques discussed above.

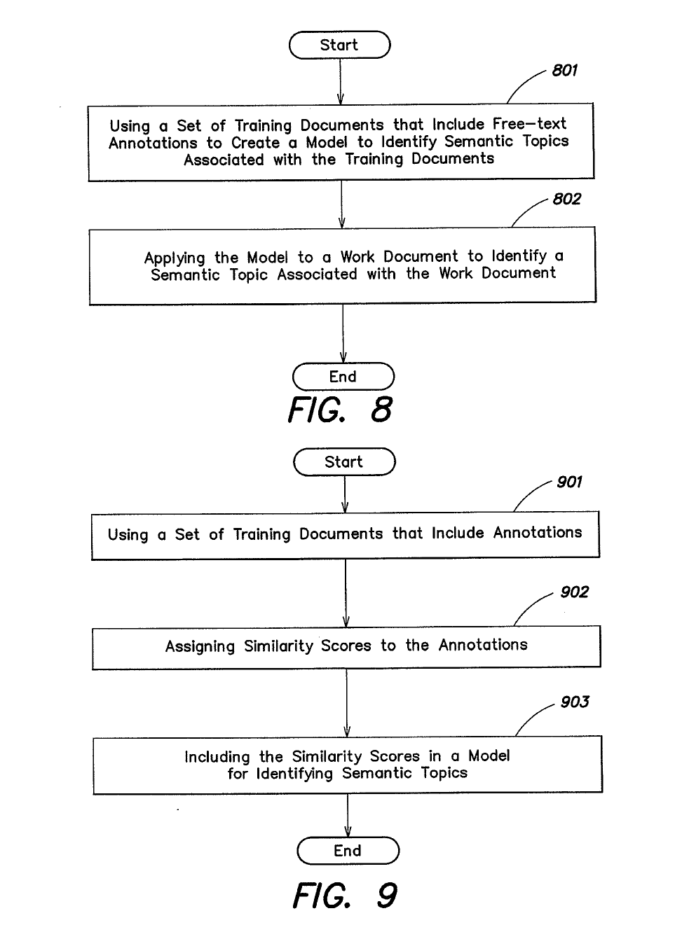

FIG. 8 shows an example of a process that may be used to identify semantic properties in documents in accordance with some embodiments of the invention as described above. The process of FIG. 8 begins at act 801, wherein a set of training documents that include free-text annotations is used to create a model that can be used to identify semantic topics associated with the training documents using any of the techniques described above. In some embodiments, the model may comprise a first sub-model for identifying semantic topics in free-text annotations and a second sub-model for identifying semantic topics in the body of a document, but the all aspects of the invention are not limited in this respect.

The process continues to act 802, wherein the model is applied to a work document to identify a semantic topic associated with the work document. The model can be applied to the work document in any suitable way. The work document may or may not have a free-text annotation.

FIG. 9 shows an example of a process that may be used to create a model that may be used to identify semantic properties in documents in accordance with some embodiments of the invention as described above. The process of FIG. 9 begins at act 901, wherein a set of training documents that include annotations is used. The documents of act 901 are not limited to any particular kind of annotations (e.g., the annotations may be free-text annotations, may be a quantifiable variable such as a ranking of 1 to 5 stars, or may be any other kind of annotation).

The process continues at act 902, wherein a similarity score may be assigned to the annotations. A similarity score for a particular annotation may provide an indication of how similar the particular annotation is to other annotations, and may be in the form of a vector or any other suitable form.

The process continues to act 903, wherein the similarity scores are included in a model for identifying semantic topics in documents. One example of a model for identifying semantic topics is shown in FIG. 7, as described above, but the invention is not limited to any particular model for identifying semantic topics.

The Computer Program Listing Appendix contains software code, which is incorporated by reference herein in its entirety, that contains exemplary implementations of one or more embodiments described herein. Some of the software code is written using the MATLAB language, and some of the software code is written using the C++ language. It should be appreciated that the aspects of the invention described herein are not limited to implementations using the software code in the Computer Program Listing Appendix, as this code provides merely illustrative implementations. Other code can be written to implement aspects of the invention in these or other languages.

The above-described embodiments of the present invention can be implemented in any of numerous ways. For example, the embodiments may be implemented using hardware, software or a combination thereof. When implemented in software, the software code can be executed on any suitable hardware processor or collection of hardware processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable storage medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

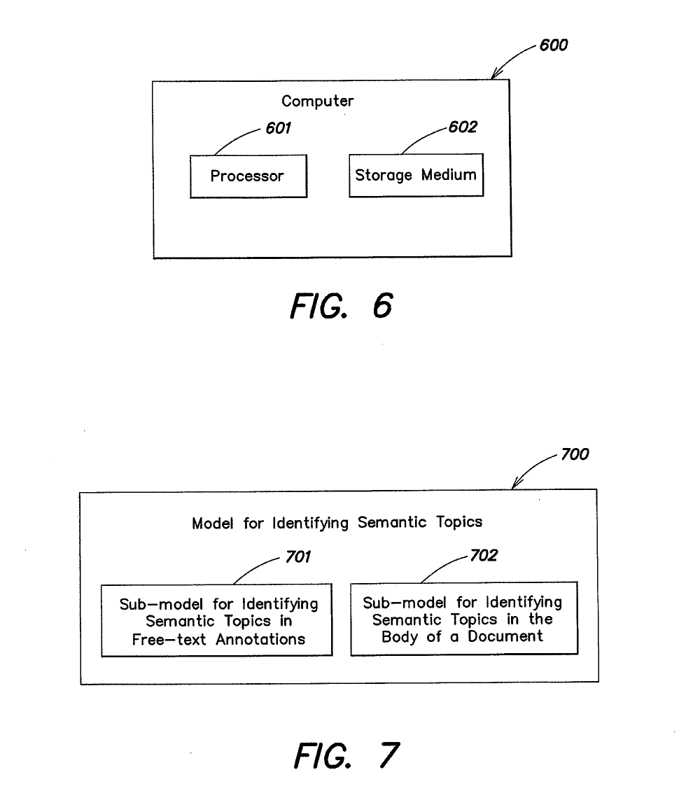

One example of a system that can be used to implement any of the embodiments of the invention described above is shown in FIG. 6. The system may comprise at least one computer 600, which may have at least one processor 601 and a storage medium 602. The storage medium may be a memory or any other type of storage medium and may store a plurality of instructions that, when executed on the at least one processor, implement any of the techniques described herein.

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method comprising acts of:
(A) using free-text annotations in a set of training documents to create a model to identify semantic topics associated with the training documents; and
(B) applying the model to at least one work document to identify at least one semantic topic associated with the at least one work document.

2. The method of claim 1, wherein the act (A) comprises an act of using the set of training documents to create a model that is able to identify two or more documents from the set of training documents as being associated with a same semantic topic even when the free-text annotations in the two or more documents use different words.

3. The method of claim 1, wherein the act (A) comprises an act of using the set of training documents to create a model that is able to learn a relationship among different free-text annotations in the training documents.

4. The method of claim 1, wherein the act (A) comprises an act of using the set of training documents to create a model that is able to identify a work document as being associated with a semantic topic even when the work document does not include the same free-text annotations as the training documents that are associated with the semantic topic.

5. The method of claim 1, wherein the act (A) comprises an act of using the set of training documents to create a model that is able to identify a free-text annotation of a work document as being associated with a semantic topic, even when the free-text annotation does not appear in the set of training documents.

6. The method of claim 1, wherein the act (A) comprises an act of using the set of training documents to create a model that is able to identify free-text annotations as being associated with a same semantic topic even when the free-text annotations use different words.

7. The method of claim 1, further comprising acts of:
(C) assigning similarity scores to some of the free-text annotations, wherein a similarity score for a particular free-text annotation provides an indication of how similar the particular free-text annotation is to other free-text annotations;
(D) providing the similarity scores to the model.

8. The method of claim 7, wherein the act (C) comprises evaluating at least one piece of information in addition to word distributions in the free-text annotations in assigning similarity scores.

9. The method of claim 1, wherein the act (A) comprises using the free-text annotations in the set of training documents to create a model comprising a first sub-model and a second sub-model, wherein the first sub-model examines free-text annotations in the at least one work document for one or more semantic topics, wherein the second sub-model examines a body of the at least one work document for one or more semantic topics, and wherein the first sub-model and the second sub-model are linked.

10. The method of claim 1, further comprising acts of:
(C) applying the model to at least one other work document to identify at least one other semantic topic associated with the at least one other work document;
(D) creating a summary of the at least one work document and the at least one other work document.

11. The method of claim 1, wherein the act (A) comprises an act of using a set of training documents that does not include professional annotations.

12. The method of claim 1, wherein the act (A) comprises an act of using a set of training documents comprising at least some training documents that do not include professional annotations.

13. A system comprising at least one processor programmed to:
(A) use free-text annotations in a set of training documents to create a model to identify semantic topics associated with the training documents; and
(B) apply the model to at least one work document to identify at least one semantic topic associated with the at least one work document.

14. The system of claim 13, wherein the model is able to identify two or more documents from the set of training documents as being associated with a same semantic topic even when the free-text annotations in the two or more documents use different words.

15. The system of claim 13, wherein the model is able to identify a work document as being associated with a semantic topic even when the work document does not include the same free-text annotations as the training documents that are associated with the semantic topic.

16. The system of claim 13, wherein the model is able to identify a free-text annotation of a work document as being associated with a semantic topic, even when the free-text annotation does not appear in the set of training documents.

17. The system of claim 13, wherein the model is able to identify free-text annotations as being associated with a same semantic topic even when the free-text annotations use different words.

18. The system of claim 13, wherein the at least one processor is further programmed to:
(C) assign similarity scores to some of the free-text annotations, wherein a similarity score for a particular free-text annotation provides an indication of how similar the particular free-text annotation is to other free-text annotations;
(D) provide the similarity scores to the model.

19. The system of claim 18, wherein the similarity scores are based on evaluating at least one piece of information in addition to word distributions in the free-text annotations.

20. The system of claim 13, wherein the model comprises a first sub-model and a second sub-model, wherein the first sub-model examines free-text annotations in the at least one work document for one or more semantic topics, wherein the second sub-model examines a body of the at least one work document for one or more semantic topics, and wherein the first sub-model and the second sub-model are linked.

21. The system of claim 13, wherein the at least one processor is further programmed to:
(C) apply the model to at least one other work document to identify at least one other semantic topic associated with the at least one other work document;
(D) create a summary of the at least one work document and the at least one other work document.

22. The system of claim 13, wherein the training documents do not include professional annotations.

23. At least one computer readable storage medium encoded with instructions that, when executed, perform a method comprising acts of:
(A) using free-text annotations in a set of training documents to create a model to identify semantic topics associated with the training documents; and
(B) applying the model to at least one work document to identify at least one semantic topic associated with the at least one work document.

24. The at least one computer readable storage medium of claim 23, wherein the act (A) comprises an act of using the set of training documents to create a model that is able to identify two or more documents from the set of training documents as being associated with a same semantic topic even when the free-text annotations in the two or more documents use different words.

25. The at least one computer readable storage medium of claim 23, wherein the act (A) comprises an act of using the set of training documents to create a model that is able to identify a work document as being associated with a semantic topic even when the work document does not include the same free-text annotations as the training documents that are associated with the semantic topic.

26. The at least one computer readable storage medium of claim 23, wherein the act (A) comprises an act of using the set of training documents to create a model that is able to identify a free-text annotation of a work document as being associated with a semantic topic, even when the free-text annotation does not appear in the set of training documents.

27. The at least one computer readable storage medium of claim 23, wherein the method further comprises acts of:
(C) assigning similarity scores to some of the free-text annotations, wherein a similarity score for a particular free-text annotation provides an indication of how similar the particular free-text annotation is to other free-text annotations;
(D) providing the similarity scores to the model.

28. The at least one computer readable storage medium of claim 27, wherein the act (C) comprises evaluating at least one piece of information in addition to word distributions in the free-text annotations in assigning similarity scores.

29. The at least one computer readable storage medium of claim 23, wherein the act (A) comprises using the free-text annotations in the set of training documents to create a model comprising a first sub-model and a second sub-model, wherein the first sub-model examines free-text annotations in the at least one work document for one or more semantic topics, wherein the second sub-model examines a body of the at least one work document for one or more semantic topics, and wherein the first sub-model and the second sub-model are linked.

30. The at least one computer readable storage medium of claim 23, wherein the method further comprises acts of:
(C) applying the model to at least one other work document to identify at least one other semantic topic associated with the at least one other work document;
(D) creating a summary of the at least one work document and the at least one other work document.

31. The at least one computer readable storage medium of claim 23, wherein the act (A) comprises an act of using a set of training documents that does not include professional annotations.

32. A method for creating a model to associate one or more work documents with one or more semantic topics, the method comprising acts of:
(A) using a set of training documents that include annotations;
(B) assigning similarity scores to some of the annotations, wherein a similarity score for a particular annotation provides an indication of how similar the particular annotation is to other annotations;
(C) providing the similarity scores to the model.

33. The method of claim 32, wherein the act (B) comprises evaluating at least one piece of information in addition to word distributions in the annotations in assigning similarity scores.

34. The method of claim 32, wherein the annotations are free-text annotations.

35. A system comprising:
at least one processor programmed to create a model to associate one or more work documents with one or more semantic topics by:
using a set of training documents that include annotations;
assigning similarity scores to some of the annotations, wherein a similarity score for a particular annotation provides an indication of how similar the particular annotation is to other annotations;
providing the similarity scores to the model.

36. The system of claim 35, wherein the at least one processor is programmed to assign the similarity scores by evaluating at least one piece of information in addition to word distributions in the annotations in assigning the similarity scores.

37. The system of claim 35, wherein the annotations are free-text annotations.

38. At least one computer readable storage medium encoded with instructions that, when executed, perform a method for creating a model to associate one or more work documents with one or more semantic topics, the method comprising acts of:
(A) using a set of training documents that include annotations;
(B) assigning similarity scores to some of the annotations, wherein a similarity score for a particular annotation provides an indication of how similar the particular annotation is to other annotations;
(C) providing the similarity scores to the model.

39. The at least one computer readable storage medium of claim 38, wherein the act (B) comprises evaluating at least one piece of information in addition to word distributions in the annotations in assigning similarity scores.

40. The at least one computer readable storage medium of claim 38, wherein the annotations are free-text annotations.
